(19) United States
(12) Patent Application Publication
(10) Pub. No.: US 2007/0252008 A1
(43) Pub. Date: Nov. 1, 2007

(54) Position indicator using a moveable sensor and a light path viewed

(76) Inventor: James Carroll Rowe, Albuquerque, NM (US)

Correspondence Address: JAMES C. ROWE, 7512 DON GASPAR DR. N.E., ALBUQUERQUE, NM, 87109, US

(21) Appl. No.: 11/740,285

(22) Filed: Apr. 25, 2007

Related U.S. Application Data
(60) Provisional application No. 60/745,843, filed on Apr. 27, 2006.

(51) Int. Cl. G06K 7/10

(52) U.S. Cl. 235/472.01

(57) ABSTRACT

A position indicator that uses light and a light tight cover with ports installed over a clear tube and an internal moveable sensor with both light blocking and collecting/reflecting properties inside the tube to show a position by means of a light path and view port. The position can be read locally with the eye or remotely with an optical fiber or optical device from the view port.

The present invention relates generally to position indication in process measurement, using materials and technology not previously applied in this application. A typical application for position indication would be in process measurement devices that are coupled magnetically to ferrous sensors in a process stream. Use of ferrous materials has limited applications in aggressive service. The bright path position indicator/sensor hereafter called “Brightpath Sensor” contains no ferrous materials and uses light as a means of position indication. It is a device made of common materials that can be obtained at most local hardware stores. The moveable sensor is designed to work inside a clear/translucent round tube. The sensor is constructed with 5 basic components. The components are
1. A clear/translucent round tube such as glass, clear PVC, vinyl, Teflon®. These are materials that allow light to pass through the wall of the tube and be observed.
2. A light tight cover that will be drilled through and installed over the tube to create the target and view ports (positions) that will be part of this invention.
3. A moveable sensor made of light blocking and light collecting/reflecting materials (can be same as tube material) in a sandwich configuration that will be machined and polished for close fit to the ID of the tube.
4. Light ( i.e. LED, light bar, fiber optic light)
5. A start and stop position

Operation of the Brightpath Sensor.

The Brightpath Sensor is all about manipulating light. Blocking the light path (with the light blocking parts of the moveable sensor), and then, viewing the light path (with light collecting/reflecting part of the sensor) to show a position in the view port. The bright path is created when there is light in the installed target port aligned with the light collecting/reflecting part of the moveable sensor and view port. The sensor should be installed in an area of subdued light or the light tight cover should be extended past the desired position range to prevent ambient light interference with the operation of the sensor. Motivating the sensor will be its application. Potential uses would be in flow devices, position indication and pressure sensing devices to name a few.

### BRIEF SUMMARY OF THE INVENTION

The Invention comprises a novel application of materials and technology for process measurement not previously applied in this application. The sensor uses a clear/transparent tube with a light tight cover with ports for light installation and view, installed over the tube and a moveable sensor inside the tube when aligned with the ports creates a bright path that can be observed and that would be the position indicated. The materials used in this invention are typically the same materials that aggressive chemicals are stored and shipped in. The Brightpath Sensor (position indicator) will be adaptable to flow, pressure; differential pressure applications to name a few. Having described the subject matter with supporting documentation of its works, it should be obvious that many modifications and variations of this invention are possible.

### EXPLANATION OF DRAWINGS

Note—All drawings shown represent a tube measurement of ½″ OD. The light tight cover is greater than tube OD and sensors are less than tube ID. All information is correct and prototype tested ⅜″ thru 1″ OD tube.

FIG. 1

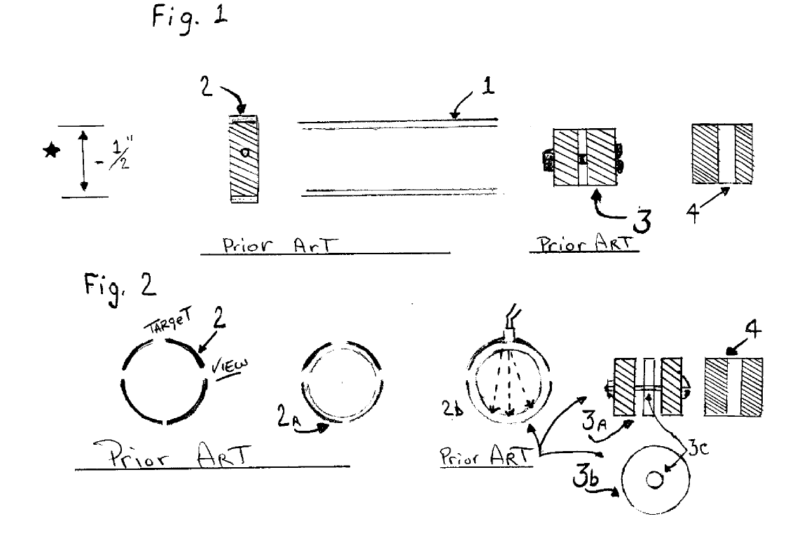

1: Clear tube

2: Light tight cover with view port illustrated

3: Assembled moveable sensor, a sandwich construction with light blocking and light collecting/reflecting properties

4: Bonded moveable sensor, a sandwich construction with light blocking and light collecting/reflecting properties

FIG. 2

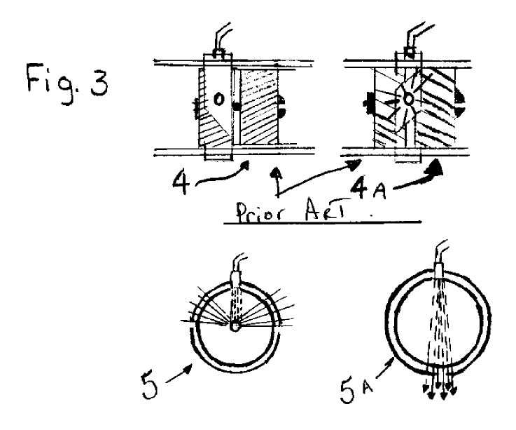

2: Light tight cover with target and view ports illustrated. Target port shown at 12 o'clock, view ports at approximately 9 and 3 o'clock. Note, view ports shown at the 9 and 3 o'clock position are for illustration purposes only, best reflective view port angle varies with both, the target port size and the thru hole size drilled in the assembled moveable sensor (3b). Best port locations for the bonded moveable sensor are 12 o'clock (target) and 6 o'clock (view)

2a: Light tight cover with ports and clear tube installed

2b: Light tight cover with view ports and clear tube with LED installed for light with beam paths (illustration) in empty tube (no sensor present).

3a: Assembled moveable sensor; exploded view showing the light blocking and light collecting/reflecting parts of sensor; also screw and bolt that hold moveable sensor together. The light collecting/reflecting part of the sensor shall be a clear or translucent material that allows light to travel through it.

3b: Side view of one of the sections of the assembled moveable sensor with center hole drilled, both for assembly and in the light collecting section, a creation of a reflecting/collecting zone.

3c: Main reflecting zone for the collecting/reflecting part of the assembled moveable sensor.

4: Bonded moveable sensor, heat bonded or appropriate adhesive (bond) for application. Clear material allows light to pass through sensor with little degrading of light signal.

FIG. 3

4: The clear tube with light tight cover installed (cut away) with view port showing and LED installed for light and the assembled moveable sensor in the light blocking position.

4a: The clear tube with light tight cover installed (cut away) and view port showing and LED installed for light and the assembled moveable sensor in the light indicating position.

5: Illustration of LED installed for light in target port beam paths for the assembled moveable sensor in the collecting/reflecting zone.

5a: Illustration of LED installed for light in target port beam path through the bonded moveable sensor.

What is claimed is:

1. A position indicator to be used in process measurement that uses a round clear/translucent tube and a light tight cover with ports installed over the tube and moveable sensor installed inside the tube to show a position. The device will be able to operate in any position.

2. The position indicator of claim 1 uses a clear/translucent tube such as glass, clear PVC, vinyl, Teflon®. Any tube material that allows light to pass through the wall of the tube and through the sensor and be observed in the view port can be used.

3. The position indicator of claim 2 uses a light tight cover that will fit over the outside of the tube with ports drilled thru the cover to create entry and exits for light to enter and exit the tube when aligned with the moveable sensor. When assembling, the ports will be drilled before installing the light tight cover over the tube. The port that will be used for the introduction of light into the position indicator is the target port. The port that light will be observed through the moveable sensor is the view port. The ports shall be aligned and perpendicular to the run of the tube or at right angles to the tube (┐).

4. The position indicator of claim 3 has a target port drilled through the light tight cover which is installed over the tube. The target port will be drilled at the 0° angle or starting point, 12 o'clock in clock terms. The target port is where light (light bulb, LED, fiber optic light, etc.) will be installed to introduce light into the position indicator.

5. The position indicator of claim 4 provides for entry of light into the indicator tube through the target port. When the light tight cover is installed over the tube, ports that have been drilled have access to the tube from the outside of the tube. This means, the light that has been installed in the target port enters the tube as a beam or stream of light, TEFLON® is a registered Trademark of E. I. du Pont de Nemours and Company not all Illuminating as if installed in the tube. This beam of light will flood the light collecting/reflecting parts of the moveable sensor to be observed thru the view ports.

6. The position indicator of claim 5 has a view port drilled in the light tight cover which is installed over the tube. The best reflective view port locations for the assembled moveable sensor varies with the thru hole size drilled for both assembly and creation of the main collecting/reflecting zone and also size of the target port. Favorable results are obtained when using the following dimensions for both the target and view ports 17-24% of the OD of the clear tube; for example, for ½″ OD the drilled hole would be from 0.085-0.120″ for the ports. Best view port locations for the assembled moveable sensor are between the 2 and 3 and 9 and 10 o'clock position. Favorable results are achieved when using a thru hole size in the assembled sensor of 33.5-35% of the OD of the sensor, in this case 0.120-0.125″ with the OD of the moveable sensor ≈0.360″. The best view port location for the bonded moveable sensor will be the 6 o'clock position, since there is no hole drilled in this sensor, the light flows through it to the view port from the target port.

7. The position indicator of claim 6 uses a moveable sensor that will connect internally, the lighted target port and view port to create the bright path. The assembled moveable sensor is constructed from non ferrous materials of both, light blocking and light collecting/reflecting properties. The light blocking material can be any material that will be compatible with the process that is to be monitored and that will not allow light to penetrate it. The light collecting/reflecting portion of the sensor needs to be clear/translucent enough when aligned internally with the target and view ports to allow the light to be observed. The thickness of the light blocking material for the sensor should be wide enough when assembled with the clear/translucent material to create the desired dead zone and live zone so the light can be observed. The clear portion of the moveable sensor should be at least as wide as the view port. The materials for the assembled moveable sensor should be sanded so that materials will have flat surfaces that fit tightly together and will be drilled through, assembled with non ferrous bolt and nut, machined and polished for close fit on the inside diameter of the round clear/translucent tube with the appearance of one piece. The bonded moveable sensor can use the same materials as previously detailed except instead of drilling the material for assembly, the parts are bonded with the appropriate adhesive or heat bonded machined and polished for close fit to the inside diameter of the tube. Both methods will yield a favorable sensor that will internally connect the lighted target port and view port for observation.

8. The position indicator of claim 7 uses a start and stop position. This will be determined by the application and the user.
